(19) United States
(12) Patent Application Publication
(10) Pub. No.: US 2015/0234099 A1
(43) Pub. Date: Aug. 20, 2015

(54) METHOD FOR PRODUCING LIGHT CONTROL PANEL

(71) Applicant: Asukanet Company, Ltd., Hiroshima-shi, Hiroshima (JP)

(72) Inventor: Makoto Otsubo, Hiroshima-shi (JP)

(73) Assignees: ASUKANET COMPANY, LTD., Hiroshima-shi, Hiroshima (JP); ASUKANET COMPANY, LTD., Hiroshima-shi, Hiroshima (JP)

(21) Appl. No.: 14/429,695

(22) PCT Filed: Nov. 8, 2013
(86) PCT No.: PCT/JP2013/080288

§ 371 Date: Mar. 19, 2015

(30) Foreign Application Priority Data
Nov. 8, 2012 (JP) 2012-246263

(51) Int. Cl. G02B 5/08; B32B 38/00

(52) U.S. Cl. CPC G02B 5/08; B32B 38/0004; B32B 2307/416; B32B 2315/08; B32B 2551/08

(57) ABSTRACT

A method for producing a light control panel includes a first step of forming a block 19 in which transparent sheets 16 of glass, ceramic or transparent plastic and mirror sheets 17 each having a metallic reflective surface on one side or both sides are alternately stacked and laminated, and a second step of forming a first light control panel 13 and a second light control panel 14 to be stacked with planar light-reflective portions 11, 12 of each of the first and the second light control panels 13, 14 in a crossed state, the first and the second light control panels 13, 14 being arranged opposed to each other, by cutting out from the block 19 on a surface crossing the transparent sheets 16 and the mirror sheets 17 in a manner that makes the thickness of a cutout constant.

### TECHNICAL FIELD

The present invention relates to a method for producing a light control panel for use in an optical imaging apparatus that forms a volumetric image in the air.

### BACKGROUND ART

As an optical imaging apparatus that forms a volumetric image by using light (scattering light) emitted from the surface of an object, Patent Literature 1 describes a technique to form an image of an object on the side opposite to the optical imaging apparatus by using a first light control panel and a second light control panel each formed by arranging, inside a transparent flat plate, a number of belt-like planar light-reflective portions perpendicularly to a surface on one side of the transparent flat plate, making one side of each of the first and the second light control panels face to face with each other in a manner that makes the planar light-reflective portions of the first light control panel and the planar light-reflective portions of the second light control panel orthogonal to one another, making light from the object (or a light source) incident upon the planar light-reflective portions of the first light control panel, and making reflected light reflected at these planar light-reflective portions re-reflect at the planar light-reflective portions of the second light control panel.

Also, Patent Literature 1 discloses making of a light control panel by making a laminated body through laminating a number of transparent synthetic resin plates (e.g., acrylic resin plates) or glass plates each having a metallic reflective surface consisting of a deposited layer (or a plated layer) of aluminum, silver or the like, which are examples of metals (the metallic reflective surface therefore becomes a both-sided reflective plate), formed on one surface side and each having a constant thickness in a manner that makes each metallic reflective surface arranged on one side, and through cutting out from this laminated body in a manner that forms a cut-out surface perpendicular to each metallic reflective surface.

Additionally, Patent Literature 2 also describes producing of light control panels by laminating a plurality of planar mirrors and cutting them in a longitudinal direction, and producing of a planar mirror by forming through methods such as one to deposit a metallic film such as tin, silver and aluminum on the surface of acrylic, glass and the like.

### CITATION LIST

### Patent Literature

Patent Literature 1: WO 2009/131128

Patent Literature 2: Japanese Unexamined Patent Application Publication No. 2011-081300

### SUMMARY OF INVENTION

### Technical Problem

However, producing light control panels by depositing a metallic reflective layer on the surface of a transparent synthetic resin plate, glass plate and the like requires a special deposition apparatus and is also time-consuming, there has been a problem of not being able to achieve inexpensive mass production. Moreover, sheets having metallic reflective surfaces formed thereon need to be laminated in large numbers in the end, which has made the work of laminating using an adhesive agent necessary.

The present invention has been made in view of the above circumstances, and an object thereof is to provide a method for producing a light control panel that is easily produced and for use in an optical imaging apparatus.

### Solution to Problem

In order to achieve the above object, a method for producing a light control panel according to the present invention for use in an optical imaging apparatus is a method for producing a first light control panel and a second light control panel of an optical imaging apparatus each formed by arranging belt-like planar light-reflective portions at a constant pitch inside a transparent flat plate, and arranging opposed to each other the first light control panel and the second light control panel in a manner that makes the planar light-reflective portions of the first light control panel and the planar light-reflective portions of the second light control panel cross one another, the method for producing a light control panel, including:
a first step of forming a block in which transparent sheets made of glass, ceramic or transparent plastic and mirror sheets each having a metallic reflective surface on both sides or one side of a piece of metal, glass or resin are alternately stacked and laminated; and
a second step of forming the first or the second light control panel by cutting out from the block on a surface crossing the transparent sheets and the mirror sheets in a manner that makes the thickness of a cutout constant.

In the case of the method for producing a light control panel according to the present invention, the mirror sheets may be those in which metal is deposited on one side or both sides of thin glass plates. Additionally, the mirror sheets may be those in which metal is deposited on one side or both sides of thin resin plates, and depending on conditions, may be metallic plates (excluding copper and gold).

In the case of the method for producing a light control panel according to the present invention, it is preferable to use a transparent adhesive agent for the joining of the transparent sheets and the mirror sheets. Here, it is preferable for the transparent adhesive agent to be a UV curing-type adhesive agent, and in this case, the UV curing-type adhesive agent is able to be cured by ultraviolet light irradiated from a direction orthogonal to the plate thickness of the transparent sheets.

A thermosetting-type adhesive agent may also be used as the adhesive agent, and the adhesive agent may be cured by induction heating, dielectric heating (microwaves), or furnace heating.

In the case of the method for producing a light control panel according to the present invention, the mirror sheets may be preliminarily attached to one side or both sides of the transparent sheets, and transparent sheets having mirrors to which the mirror sheets are attached may be laminated.

In the case of the method for producing a light control panel according to the present invention, it is preferable for the thickness of the transparent sheets to be in the range of 300 to 1000 μm, and for the thickness of the mirror sheets to be in the range of 30 to 100 μm. Easy inflection is allowed in these ranges even when mirror sheets are those in which metal having high light reflectivity such as aluminum and silver is deposited on one side or both sides of glass plates, and Ra value for the degree of mirror surface roughness stays low.

### Advantageous Effects of Invention

In the case of the method for producing a light control panel according to the present invention, since the mirror surfaces to be arranged between each transparent sheet is produced not by deposition but by using independent mirror sheets, the production process becomes extremely simplified, and light control panels can be produced at a low cost, thereby enabling the provision of an optical imaging apparatus that forms a volumetric image at a lower cost.

Especially, when a UV curing-type adhesive agent is used as the adhesive agent to join the transparent sheets and the mirror sheets, the adhesive agent can be cured by irradiating ultraviolet light from the lateral side of the block.

Additionally, even when a thermosetting-type adhesive agent is used, the adhesive agent can be easily heated and cured by induction heating, microwaves, or furnace heating.

### BRIEF DESCRIPTION OF DRAWINGS

FIG. 1 is an explanatory diagram of a method for producing a light control panel according to one embodiment of the present invention.

FIG. 2 is an explanatory diagram of an optical imaging apparatus in which light control panels produced by the same method is used.

FIG. 3 is an explanatory diagram of processes of the same method.

FIG. 4 is an explanatory diagram of processes of the same method.

### DESCRIPTION OF EMBODIMENTS

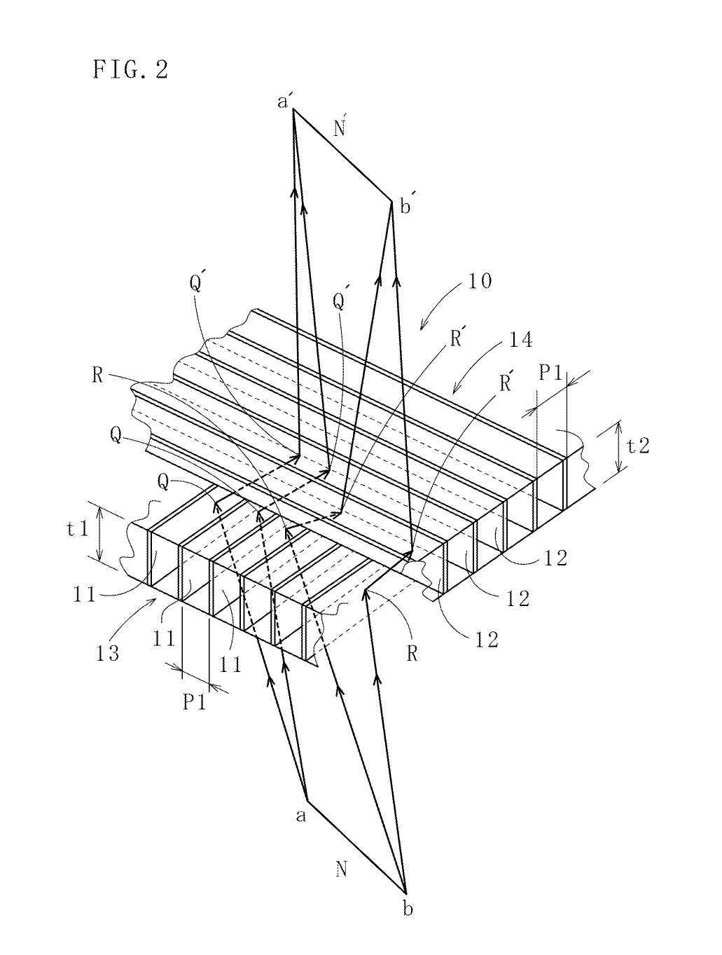

Next, with reference to the accompanying drawings, descriptions will be given on a method for producing a light control panel according to embodiments of the present invention. First, with reference to FIG. 2, descriptions will be given on an optical imaging apparatus 10 in which light control panels produced by a method for producing a light control panel according to one embodiment of the present invention are used.

As illustrated in FIG. 2, the optical imaging apparatus 10 is produced by using a first light control panel 13 and a second light control panel 14 formed by arranging, inside two transparent flat plates in the thickness direction of the transparent flat plates, a number of belt-like planar light-reflective portions 11 and 12 consisting of metallic reflective surfaces (e.g., aluminum, silver, titanium, tin, etc.) at a constant pitch p1, and making one side of each of the first and the second light control panels 13 and 14 face to face and coherent with each other in a manner that makes the planar light-reflective portions 11 and the planar light-reflective portions 12 cross (e.g., orthogonal to) one another. The planar light-reflective portions 11 and 12 are arranged perpendicularly to the surfaces of the transparent flat plates, however, they may also be arranged inclined.

Here, it is preferable for the pitches p1 between the planar light-reflective portions 11 and between the planar light-reflective portions 12 each to be approximately 0.1- to 3-fold (more preferably, 0.1- to 2-fold, even more preferably, 0.2- to 0.5-fold) of the thicknesses t1 and t2 of the first and the second light control panels 13 and 14. Although the thicknesses t1 and t2 of the first and the second light control panels 13 and 14 vary depending on the intended use, they are in the range of 0.5 to 10 mm, the first and the second light control panels 13 and 14 each have, for example, 300 to 2000 pieces of the planar light-reflective portions 11 and 12. Hence, if the first and the second light control panels 13 and 14 are made to be square-shaped in planar view, the optical imaging apparatus 10 having 90,000 to 4,000,000 picture elements can be obtained.

In the case of the optical imaging apparatus 10, light rays from a point a of an object N regularly reflect at points Q of the planar light-reflective portions 11 of the first light control panel 13, subsequently reflect at points Q′ of the planar light-reflective portions 12 of the second light control panel 14, and become concentrated at a point a′. Light rays from a point b of the object N reflect at points R of the planar light-reflective portions 11 of the first light control panel 13, the light rays further reflect at points R′ of the planar light-reflective portions 12 of the second light control panel 14 and become concentrated at a point b′. Therefore, by using this optical imaging apparatus 10, the object N forms a volumetric image N′ at a position symmetrical about the optical imaging apparatus 10. Details on these techniques are described in WO 2009/131128.

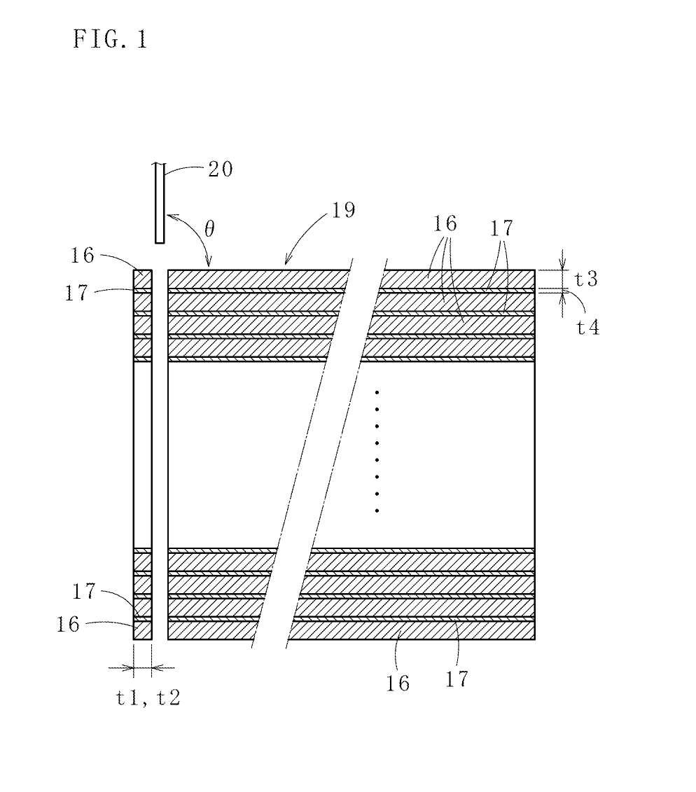

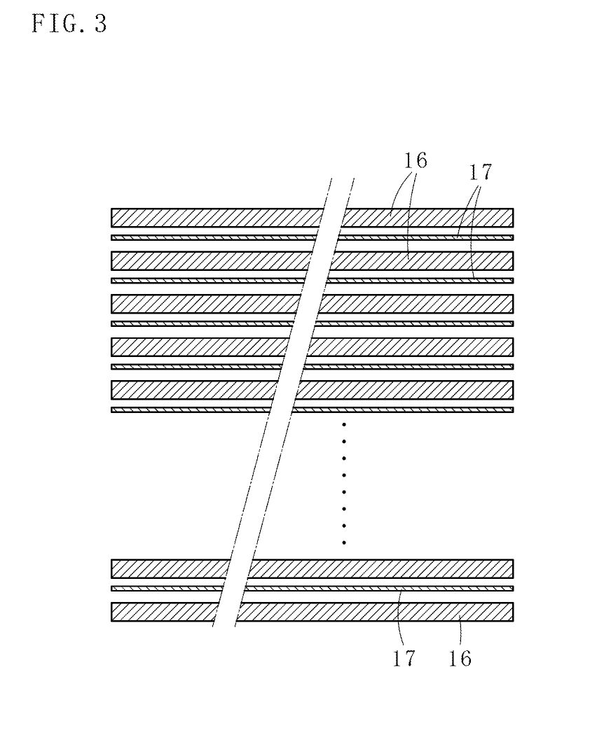

Next, with reference to FIGS. 1, 3 and 4, descriptions will be given on a method for producing a light control panel according to this embodiment. As illustrated in FIG. 3, the number of transparent sheets 16 required in accordance with the size of an optical imaging apparatus 10 to be produced is prepared. The thickness t3 of the transparent sheets 16 (e.g., 300 to 1000 μm) determines the pitches p1 between the planar light-reflective portions 11 and between the planar light-reflective portions 12. The transparent sheets 16 are preferably pieces of glass, however, can also be pieces of transparent plastic (e.g., acrylic resin), ceramic and the like.

Then, mirror sheets 17 with a thickness t4 of, for example, approximately 30 to 100 μm, and consisting of glass plates having a piece of metal excluding copper and gold deposited or plated on one side or both sides thereof are prepared in plurality. However, since mirror sheets 17 are generally rolled in a roll shape, as illustrated in FIG. 3, mirror sheets 17 in a rolled state having, for example, transparent UV-curable resin (an example of UV curing-type adhesive agents) applied on one side or both sides are prepared. After that, the transparent sheets 16 and the mirror sheets 17 unrolled to be planar and having a predetermined size are alternately laminated. Therefore, on one side or both sides of the mirror sheets 17, metallic reflective surfaces are formed. Each pitch p1 (distance) between the planar light-reflective portions 11 and between the planar light-reflective portions 12 of the first and the second light control panels 13 and 14 is a value in which the thickness t4 of one of the mirror sheets 17 is added to the thickness t3 of one of the transparent sheets 16, and when the adhesive agent has a thickness, the thickness of the adhesive agent becomes added as well.

The predetermined number of the transparent sheets 16 having the mirror sheets 17 arranged thereon thereby become arranged in a stacked state. When the UV-curable resin is applied only on one side of each mirror sheet 17, the UV-curable resin becomes also applied on the surfaces of the mirror sheets 17 to come in direct contact with the other transparent sheets 16 at the time of laminating.

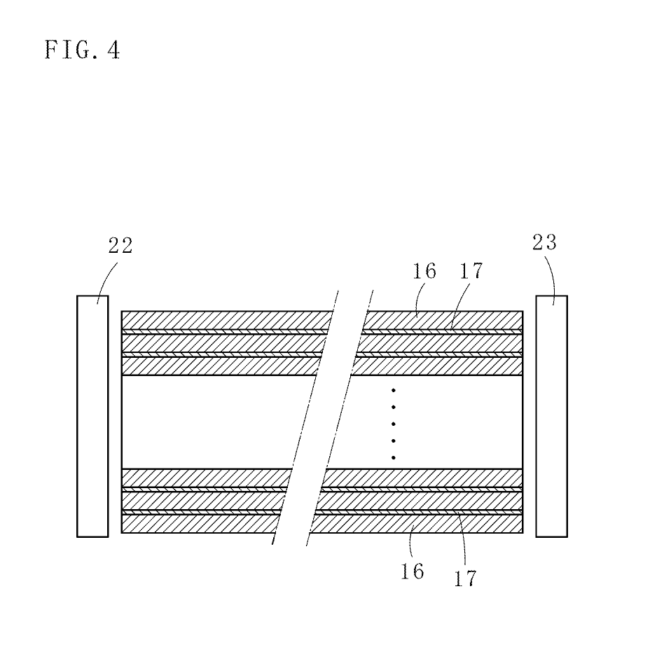

Accordingly, as illustrated in FIG. 4, the mirror sheets 17 and the transparent sheets 16 are alternately laminated, and ultraviolet light is irradiated from the ends of the transparent sheets 16 (i.e., from directions orthogonal to or crossing the laminated direction of the transparent sheets 16). Numerals 22 and 23 indicate ultraviolet lamps.

The UV (ultraviolet)-curable resin thereby functions as an adhesive agent, and a block 19 in which the mirror sheets 17 and the transparent sheets 16 are alternately stacked becomes formed.

The block 19 becomes cut on a surface crossing (e.g., orthogonal to) the transparent sheets 16 and the mirror sheets 17 in a manner that makes the thickness of a cutout constant by a cutter 20. The cutting angle θ of the cutter 20 is made to be 90 degrees, however, depending on, for example, the intended purposes, other angles (e.g., 70 degrees<θ<90 degrees) can also be applied. In this case, since just the cutter 20 simply cutting the block 19 causes asperity in the cut surface, after the cutting, the surface becomes ground and polished to make the thicknesses of cutouts t1 and t2. A little accidental error in these thicknesses, t1 and t2, does not cause any problem in the function. Making the cutting angle smaller than 90 degrees enables the enlargement and minification of an image.

Since the first and the second light control panels 13 and 14 are thereby produced, by joining the first and the second light control panels 13 and 14 in a manner that makes the planar light-reflective portions 11 of the first light control panel 13 and the planar light-reflective portions 12 of the second light control panel 14 cross (e.g., orthogonal to) one another, the optical imaging apparatus 10 becomes completed. In this case, a transparent plate may be arranged in between the first and the second light control panels 13 and 14.

In the case of the above embodiment, the first and the second light control panels 13 and 14 are joined in a manner that makes each planar light-reflective portion 11 of the first light control panel 13 and each planar light-reflective portion 12 of the second light control panel 14 orthogonal to one another in planar view. However, an optical imaging apparatus can also be formed by making them cross at an angle that is smaller than 90 degrees. In the above case, the position of a real image (volumetric image) becomes different, and in some cases, the real image (volumetric image) becomes enlarged or minified.

In the above embodiment, lamination was performed by using the separate pieces of transparent sheets 16 and mirror sheets 17, however, the first and the second light control panels can also be made by, after preparing transparent sheets having mirrors made by preliminarily sticking (or joining) the mirror sheets 17 on (to) (either one side or both sides of) the transparent sheets 16, laminating these transparent sheets having mirrors by using an adhesive agent to make a block, and cutting the block in the thickness direction of the laminated body to a predetermined cutout thickness.

Also, in the above embodiment, the mirror sheets are those in which metal having reflectivity excluding copper and gold is deposited on the thin glass plates, however, thin plastic plates (resin plates) can be used in place of the thin glass plates, and depending on circumstances, thin metallic foils can be used alternatively.

Additionally, when sticking the mirror sheets on the transparent sheets, it is preferable for mirror surfaces of the mirror sheets (metallic reflective surfaces) to be in direct contact with the surfaces of the transparent sheets, however, when thin glass plates or thin plastic plates are used as a material of the mirror sheets, and the metallic reflective surfaces are formed only on one side, the glass plates or the plastic plates can be in direct contact with the transparent sheets.

In the above embodiment, as an adhesive agent, a UV curing-type adhesive agent is used, however, a regular adhesive agent can alternatively be used, and a thermosetting-type adhesive agent, a hot melt and the like can also be used alternatively.

Additionally, the present invention also applies to the case where an adhesive agent that becomes cured, in place of ultraviolet light irradiation, by means of infrared heating, far-infrared heating, induction heating or dielectric heating, and depending on circumstances, that becomes cured by being heated inside a furnace body (furnace heating) or in a normal temperature setting is used. Moreover, the present invention is not limited to the above embodiment, and the present invention also applies to a case where the dimension and the shape are changed and a case where an additional new component is added within the range that does not alter the gist of the present invention.

### INDUSTRIAL APPLICABILITY

By the method for producing a light control panel according to the present invention, light control panels capable of forming a volumetric image as a real image can be produced at a low cost and in large quantity. These light control panels can be applied to displays of televisions, mobile phones, medical equipments and other uses.

### REFERENCE SIGNS LIST

10: optical imaging apparatus, 11, 12: planar light-reflective portion, 13: first light control panel, 14: second light control panel, 16: transparent sheet, 17: mirror sheet, 19: block, 20: cutter, 22, 23: ultraviolet lamp

1.-9. (canceled)

10. A method for producing a light control panel that is a method for producing a first light control panel and a second light control panel of an optical imaging apparatus each formed by arranging belt-like planar light-reflective portions at a constant pitch inside a transparent flat plate; and arranging opposed to each other the first light control panel and the second light control panel in a manner that makes the planar light-reflective portions of the first light control panel and the planar light-reflective portions of the second light control panel cross one another, the method for producing a light control panel, comprising:
a first step of preparing mirror sheets consisting of either inflectable glass plates each having a metallic reflective surface on both sides or one side or rollable plastic plates each having a metallic reflective surface on both sides or one side, and
forming a block in which transparent sheets made of glass or transparent plastic and the mirror sheets are alternately stacked and laminated; and
a second step of forming the first or the second light control panel by cutting out from the block on a surface crossing the transparent sheets and the mirror sheets in a manner that makes the thickness of a cutout constant.

11. The method for producing a light control panel according to claim 10, wherein the mirror sheets are those in which metal is deposited on one side or both sides of the glass plates.

12. The method for producing a light control panel according to claim 10, wherein the mirror sheets are those in which metal is deposited on one side or both sides of the plastic plates.

13. The method for producing a light control panel according to claim 10, wherein a transparent adhesive agent is used for the joining of the transparent sheets and the mirror sheets.

14. The method for producing a light control panel according to claim 13, wherein the transparent adhesive agent is a UV curing-type adhesive agent, and is cured by ultraviolet light irradiated from a direction orthogonal to the plate thickness of the transparent sheets.

15. The method for producing a light control panel according to claim 13, wherein a thermosetting-type adhesive agent is used as the adhesive agent, and the adhesive agent is cured by induction heating, dielectric heating or furnace heating.

16. The method for producing a light control panel according to claim 10, wherein the thickness of the transparent sheets is in the range of 300 to 1000 μm, and the thickness of the mirror sheets is in the range of 30 to 100 μm.
